(19) United States
(12) Patent Application Publication
(10) Pub. No.: US 2026/0192327 A1
(43) Pub. Date: Jul. 9, 2026

(54) UTILITY METER PAINT SHIELD

(71) Applicant: Talon Sutherland, Taylors, SC (US)

(72) Inventor: Talon Sutherland, Taylors, SC (US)

(21) Appl. No.: 19/224,844

(22) Filed: Jun. 1, 2025

Related U.S. Application Data
(60) Provisional application No. 63/726,576, filed on Jan. 8, 2025.

(51) Int. Cl. B05C 21/00

(52) U.S. Cl. CPC B05C 21/005

(57) ABSTRACT

The present disclosure provides a protective cover for shielding a smart meter index during painting operations. The protective cover includes a cover body having a front surface, a top surface, a right surface, a left surface, and an open bottom, wherein the cover body defines an internal cavity configured to receive a meter index of a smart meter. An angled shield extends from the top surface at an angle between 5 degrees and 90 degrees to cover meter identification information when installed. The cover body includes recesses to accommodate structural features of the smart meter and ensure proper positioning. A handle extends from one surface to facilitate manual positioning and removal. The protective cover is constructed from rigid plastic material and provides temporary protection from paint overspray while allowing easy installation and removal without tools.

### CROSS REFERENCE TO RELATED APPLICATIONS

This application claims priority to U.S. Provisional Patent Application 63/726,576 having a filing date of Jan. 8, 2025 titled NATURAL GAS SMART METER INDEX PAINT SHIELD, which is hereby incorporated by reference in its entirety.

### BACKGROUND

### 1) Field of the Invention

The present disclosure relates to protective covers for utility meters, and more particularly to a removable paint shield designed to protect smart meter display components and identification elements of the smart meter such as those present in an index.

### 2) Description of the Related Art

A smart meter is an electronic device that records information such as consumption of electric energy, gas, or water. Smart meters communicate the information to the consumer for greater clarity of consumption behavior, and to utility suppliers for system monitoring and customer billing. Smart meters enable two-way communication between the meter and the central system. Unlike traditional analog meters, smart meters can automatically collect consumption data, connect to and disconnect from service, detect tampering, and identify power outages more quickly. These devices often include digital displays and can provide real-time or near real-time energy usage information to both utilities and consumers.

Smart meters typically incorporate an index that serves as the primary interface for displaying consumption readings and meter status information. The index generally includes a liquid crystal display (LCD) that shows gas consumption data, alarm messages, and operational status. Many smart meters also feature an encoder receiver transmitter (ERT) system that enables automatic transmission of meter readings to utility companies through radio frequency communication. The ERT technology eliminates the need for manual meter reading by utility personnel and allows for remote data collection.

Meters may be painted for various reasons including increased longevity, aesthetic improvement, and protection from environmental elements. Painting can help prevent corrosion and extend the operational life of the meter housing. Additionally, painting may be performed to match the meter appearance with surrounding structures or to comply with local aesthetic requirements.

However, certain components of smart meters should not be painted as this can interfere with their functionality. The meter index, including the display screen and identification numbers, requires visibility for proper operation and maintenance. Painting over the ERT components can block radio frequency transmission and disrupt automatic meter reading capabilities. Similarly, painting over meter identification numbers, barcodes, and regulatory markings can create compliance issues and hinder maintenance procedures. Vents, regulators, and access points also require protection from paint to maintain proper meter operation and safety.

When painting meters or nearby surfaces, there is a risk of paint overspray or accidental application to sensitive meter components. Traditional masking methods can be time-consuming and may not provide adequate protection for all meter components. The need exists for protective covers that can shield meter components during painting operations while allowing easy installation and removal.

One example of a smart meter is the Honeywell AC-250 NXS. This smart meter is a widely deployed metering device in the utility industry due to its advanced communication capabilities and robust design. The meter features a distinctive curved housing with protruding index components and irregular surface contours that create complex geometries around the display and identification areas. These curved surfaces and recessed features make traditional paint masking methods particularly challenging and time-consuming, as conventional masking tape and protective materials may not conform properly to the meter's three-dimensional shape. Overspray onto one of the meter components may result in impaired functionality, reduced readability of critical information, and potential interference with communication systems.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a protective cover for a utility meter is provided. The protective cover comprises a cover body having a front surface, a top surface, a right surface, a left surface, and a bottom surface, wherein the cover body defines an internal cavity configured to receive a meter index of the utility meter. The protective cover includes an angled shield extending from the top surface at an angle between 5 degrees and 90 degrees relative to the top surface, wherein the angled shield is positioned to cover meter identification information when the protective cover is installed over the meter index. The protective cover further includes a seam recess formed in at least one surface of the cover body and configured to accommodate a meter seam of the utility meter. According to other aspects of the present disclosure, the protective cover may further comprise a handle extending from the front surface of the cover body to facilitate manual positioning and removal of the protective cover. The handle may include a handle fastener configured to secure the handle to the cover body. The protective cover may include a top tab cover formed in the cover body and configured to accommodate a meter top tab of the utility meter. The seam recess may comprise a left seam cover formed in the left surface and a right seam cover formed in the right surface. The protective cover may further comprise a side tab cover formed in at least one surface of the cover body and configured to accommodate a side tab of the utility meter. The cover body may be constructed from rigid plastic material having a thickness in the range of 1/64 inch to ¼ inch.

According to another aspect of the present disclosure, a method of protecting a utility meter during painting operations is provided. The method comprises positioning a protective cover over a meter index of the utility meter, wherein the protective cover comprises a cover body with an internal cavity, an angled shield extending from a top surface of the cover body, and a seam recess. The method includes aligning the seam recess with a meter seam of the utility meter to assist with proper placement of the protective cover. The method further comprises maintaining the protective cover in position over the meter index during painting operations to shield the meter index and meter identification information from paint contamination. According to other aspects of the present disclosure, the method may further comprise a step of grasping a handle extending from the protective cover to facilitate positioning and maintaining the protective cover over the meter index. The step of maintaining the protective cover in position may comprise holding the handle during painting operations to prevent movement of the protective cover. The step of positioning the protective cover may comprise moving the protective cover in a placement direction toward the utility meter until an internal cavity of the cover body encompasses the meter index. The method may further comprise a step of aligning a side tab cover of the protective cover with a side tab of the utility meter to enhance proper placement of the protective cover. The method may include engaging a top tab included in the cover with a top tab included in the meter to assist with securing the protective cover to the utility meter.

According to yet another aspect of the present disclosure, a method of painting a utility meter is provided. The method comprises providing a protective cover having a cover body with an internal cavity, an angled shield, a top tab cover, and a seam recess. The method includes positioning the protective cover over a meter index of the utility meter by moving the protective cover in a placement direction until the internal cavity encompasses the meter index. The method further comprises engaging the top tab cover with a meter top tab and aligning the seam recess with a meter seam to secure the protective cover in position. The method includes applying paint to surfaces of the utility meter while the protective cover shields the meter index and meter identification information from paint contamination. The method further comprises removing the protective cover from the utility meter after completing the painting operations. According to other aspects of the present disclosure, the step of providing the protective cover may comprise providing a protective cover having a handle extending from a surface of the cover body. The step of positioning the protective cover may comprise grasping the handle to facilitate moving the protective cover in the placement direction. The step of applying paint may comprise holding the handle to maintain the protective cover in position during painting operations. The step of applying paint may comprise spray painting surfaces of the utility meter while the angled shield deflects paint overspray away from the meter. The step of engaging the top tab cover with the meter top tab and aligning the seam recess with the meter seam may comprise aligning a side tab cover of the protective cover with a side tab of the utility meter. The step of removing the protective cover may comprise moving the protective cover in a direction opposite to the placement direction to disengage the top tab cover from the meter top tab and the seam recess from the meter seam.

The foregoing general description of the illustrative embodiments and the following detailed description thereof are merely exemplary aspects of the teachings of this disclosure and are not restrictive.

### BRIEF DESCRIPTION OF FIGURES

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1A illustrates an isometric view of a meter with an index cover, according to aspects of the present disclosure.

FIG. 1B illustrates an isometric view of a meter with an index cover, according to aspects of the present disclosure.

FIG. 1C illustrates a front view of the meter of FIG. 1A, according to aspects of the present disclosure.

FIG. 2 illustrates an isometric view of the index cover of FIG. 1A, according to aspects of the present disclosure.

FIG. 3 illustrates another isometric view of the index cover of FIG. 1A, according to aspects of the present disclosure.

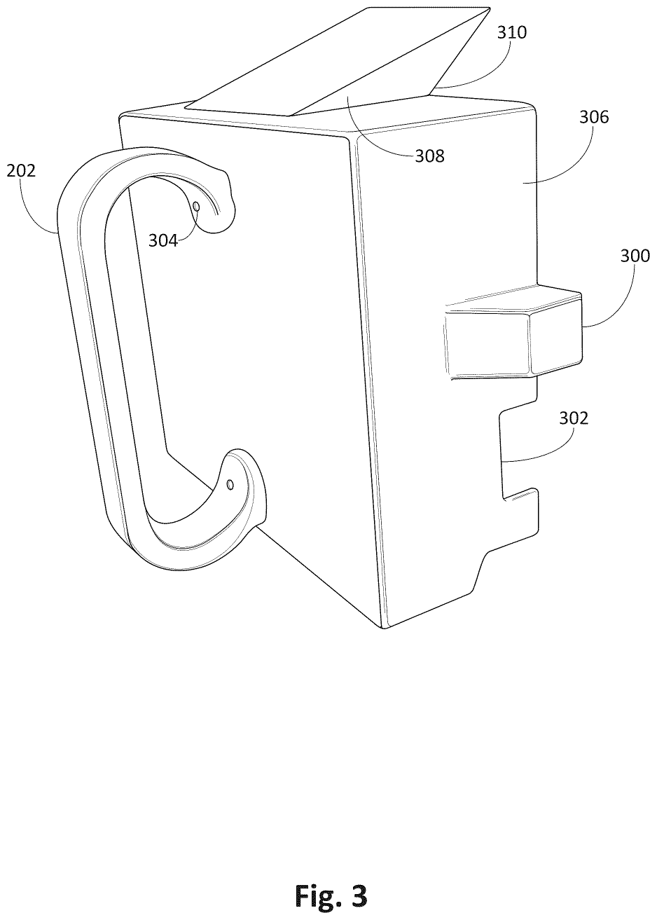

FIG. 4 illustrates an orthogonal view of the index cover of FIG. 1A, according to aspects of the present disclosure.

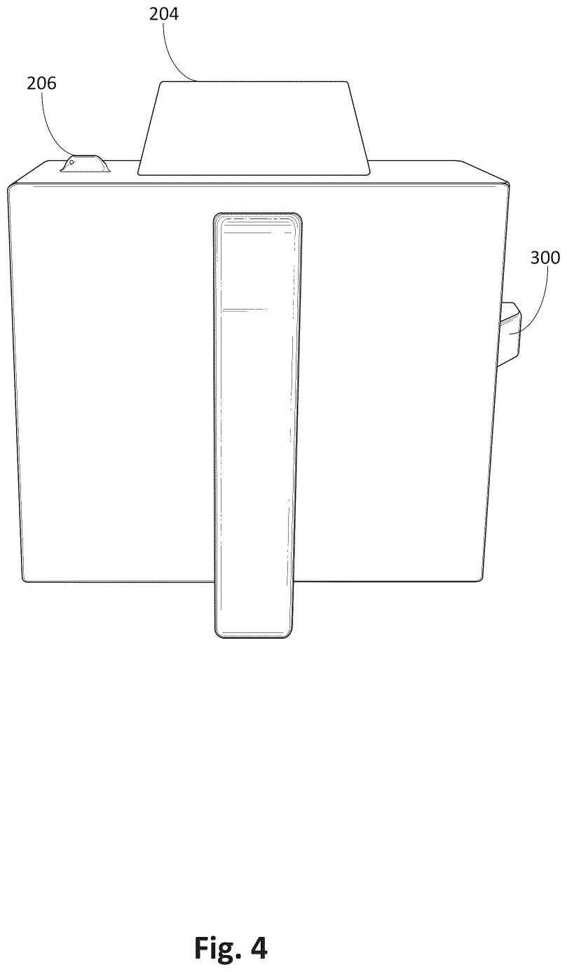

FIG. 5 illustrates an isometric view of the index cover of FIG. 1A, according to aspects of the present disclosure.

FIG. 6 illustrates a bottom view of the index cover of FIG. 1A, according to aspects of the present disclosure.

### DETAILED DESCRIPTION

The following description sets forth exemplary aspects of the present disclosure It should be recognized, however, that such description is not intended as a limitation on the scope of the present disclosure. Rather, the description also encompasses combinations and modifications to those exemplary aspects described herein.

Smart utility meters present particular challenges when painting operations occur in their vicinity. Traditional masking methods involve applying tape, paper and other protective materials around meter components, which can be time-consuming and labor-intensive. The process of carefully masking individual components such as displays, identification numbers, barcodes, and various meter features may require significant preparation time before painting can commence. Conventional masking techniques may not provide adequate protection for the complex geometries found in modern smart meters. Smart meters often include multiple protruding elements, recessed areas, and angled surfaces that can be difficult to protect using standard flat masking materials. The irregular shapes and varying depths of meter components can create gaps in protection where paint overspray may penetrate and contaminate sensitive areas.

Paint contamination of meter components can interfere with meter functionality in several ways. Paint applied to display screens can obscure readings and make meter data inaccessible to utility personnel. Paint covering identification numbers, barcodes, or ERT components can prevent proper meter identification and data transmission. In some cases, paint may interfere with ventilation openings, regulatory components, or access points that are needed for meter operation and maintenance. Further, the removal of paint from meter components after contamination has occurred can be problematic. Cleaning solvents or mechanical removal methods may damage sensitive electronic components or void manufacturer warranties. Paint that has cured on meter surfaces may be particularly difficult to remove without causing permanent damage to the underlying components. Existing protection methods may also fail to address the need for quick deployment and removal during painting operations. Temporary protection solutions that can be rapidly positioned and removed may provide advantages over traditional masking approaches that require careful application and removal of adhesive materials.

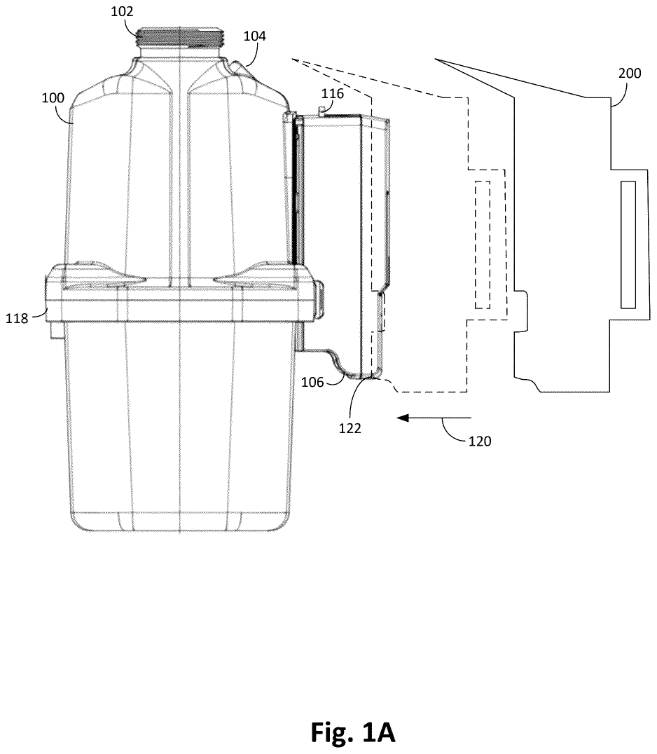

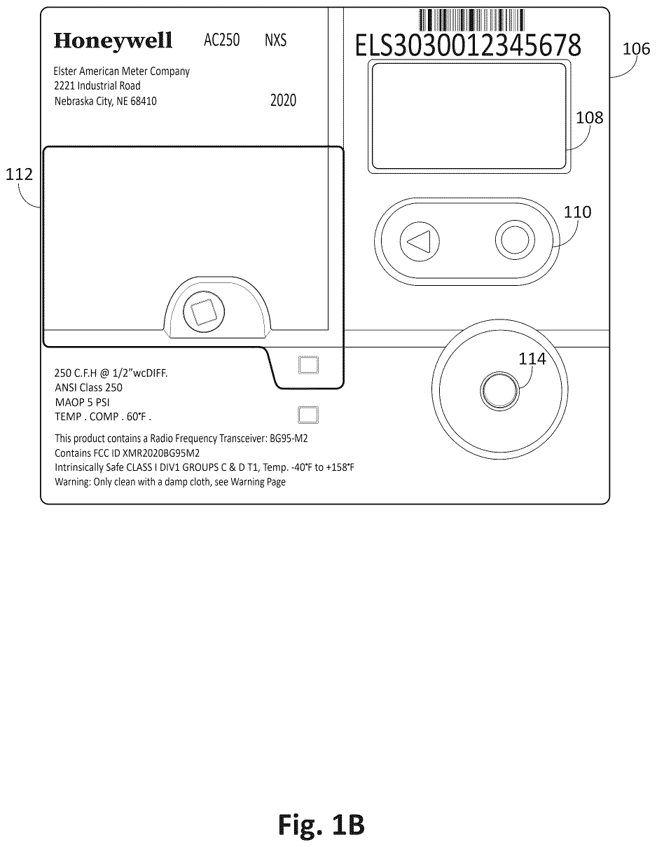

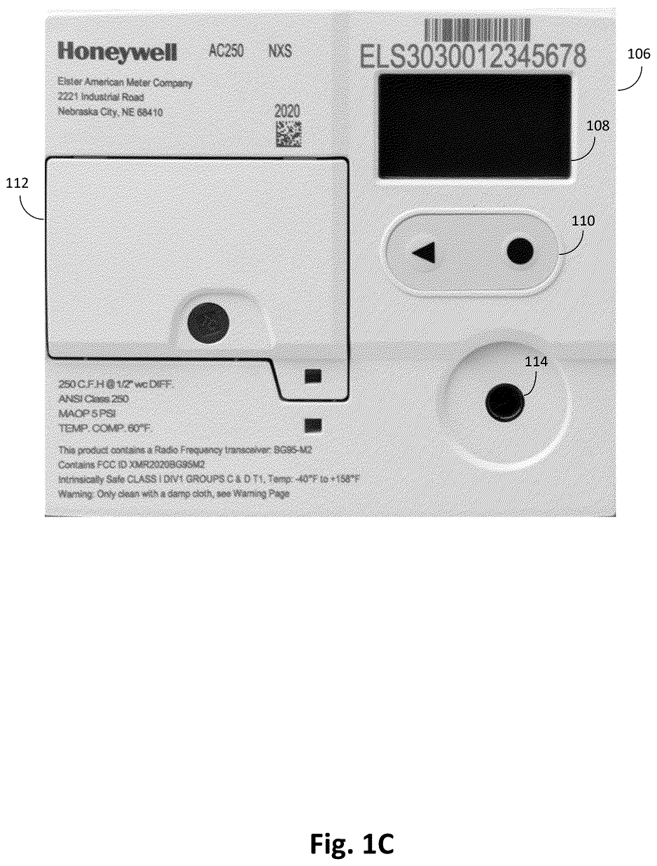

FIG. 1A illustrates an isometric view of a meter 100 with an index cover 200. The meter 100 includes a meter I/O 102, meter identification 104, and a meter index 106. The meter 100 features a meter top tab 116 and a meter seam 118 along its structure. The index cover 200 is positioned adjacent to the meter 100 and can be moved in a placement direction 120 to cover the meter index 106. A meter 100 may be configured as a smart utility meter for measuring and transmitting energy consumption data. In some cases, the meter 100 may be a Honeywell AC-250NXS smart meter that incorporates electronic measurement and communication capabilities. The meter 100 may include various components for data collection, display, and transmission functions.

An index cover 200 may be specifically designed to fit over the meter 100 and/or its index during painting operations. In some cases, the index cover 200 may be configured to fit over a Honeywell AC-250NXS smart meter ERT/Index. The index cover 200 may provide temporary protection for sensitive meter components when painting occurs in proximity to the meter 100. A placement direction 120 may define the movement path for positioning the index cover 200 over the meter 100. The index cover 200 may be moved in the placement direction 120 for placement over the meter index 106. In some cases, the placement direction 120 may facilitate proper alignment and positioning of the index cover 200 relative to the meter 100 components that require protection during painting operations.

The relationship between the meter 100 and the index cover 200 may involve a temporary covering arrangement where the index cover 200 is positioned to shield specific areas of the meter 100. The index cover 200 may be designed with dimensions and features that correspond to the physical characteristics of the meter 100 to ensure proper fitment and coverage during use.

FIG. 1B illustrates an orthogonal side view of a meter 100 with an index cover 200 positioned for installation. The meter 100 includes a meter I/O 102, meter identification 104, and a meter index 106. The meter 100 features a meter top tab 116 and a meter seam 118 along its housing structure. The meter index 106 includes an index lower extension 122 that extends from the main body of the meter index 106.

The index cover 200 is shown positioned adjacent to the meter 100 and includes a ridge 502 that corresponds to the index lower extension 122. The index cover 200 may be placed so that the ridge 502 engages the index lower extension 122, providing a positioning reference for proper alignment. The index cover 200 may be rotated in a rotational direction 218 to cover the meter index 106 after initial engagement between the ridge 502 and the index lower extension 122. The rotational direction 218 indicates the movement path for installing the index cover 200 over the meter index 106, allowing the cover to be positioned to provide protective coverage during painting operations. The engagement between the ridge 502 and the index lower extension 122 may facilitate proper positioning and alignment of the index cover 200 relative to the meter 100 components, ensuring secure placement during the rotational installation process.

FIG. 1C illustrates an orthogonal front view of the meter 100. The meter 100 may be configured as a smart utility meter that incorporates electronic measurement and communication capabilities for monitoring energy consumption. The meter 100 may include various components that enable data collection, processing, display, and transmission functions. A meter I/O 102 may be positioned on the meter 100 to provide input and output functionality. The meter I/O 102 may facilitate communication between the meter 100 and external systems or devices. In some cases, the meter I/O 102 may include connection ports, communication interfaces, or data transfer mechanisms that enable the meter 100 to exchange information with utility company systems or maintenance equipment. A meter identification 104 may be located on the meter 100 to provide identifying information for the device. The meter identification 104 may include alphanumeric characters, barcodes, or other marking systems that enable utility personnel to identify and track the specific meter 100. In some cases, the meter identification 104 may contain serial numbers, model information, or other data that corresponds to utility company records and billing systems. A meter index 106 may be positioned on the front face of the meter 100. The meter index 106 may contain the primary display and reading components of the meter 100. In some cases, the meter index 106 may house electronic display systems, measurement indicators, and user interface elements that provide access to meter data and functionality.

A meter index display 108 may be incorporated within the meter index 106. The meter index display 108 may provide visual information regarding utility consumption and meter status. In some cases, the meter index display 108 may be configured as a liquid crystal display (LCD) that presents numerical readings, alarm messages, and operational status information. The meter index display 108 may present data in real-time or near real-time intervals to provide current consumption information. Meter index controls 110 may be positioned below the meter index display 108. The meter index controls 110 may enable user interaction with the meter 100. In some cases, the meter index controls 110 may include buttons, switches, or touch-sensitive areas that allow users to navigate through different display modes, access historical data, or configure meter settings. A battery cover 112 may be located on the right side of the meter 100. The battery cover 112 may provide access to an internal power source that supplies electrical energy to the meter 100 components. In some cases, the battery cover 112 may be removable to allow for battery replacement or maintenance operations while maintaining the integrity of the meter 100 housing. A sensor 114 may be positioned adjacent to the battery cover 112. The sensor 114 may facilitate data collection and transmission functions for the meter 100. In some cases, the sensor 114 may include radio frequency components, cellular communication modules, or other wireless transmission systems that enable the meter 100 to transmit consumption data to utility company systems.

A meter top tab 116 may be formed as part of the meter 100 housing structure. The meter top tab 116 may provide a structural feature that extends from the main body of the meter 100. In some cases, the meter top tab 116 may serve as a mounting point, alignment feature, or protective element that contributes to the overall mechanical configuration of the meter 100. A meter seam 118 may be present along the structure of the meter 100. The meter seam 118 may represent a junction line where different sections of the meter 100 housing are joined together. In some cases, the meter seam 118 may indicate the boundary between removable panels, access covers, or manufacturing assembly points within the meter 100 construction.

The structural relationships between these components may create a compact configuration that integrates measurement, display, and communication capabilities within a single housing unit. The meter index 106 may serve as the primary user interface area, while the meter I/O 102 and sensor 114 may provide connectivity and data transmission functions. The meter identification 104 may enable tracking and identification of the specific meter 100 unit within utility company systems.

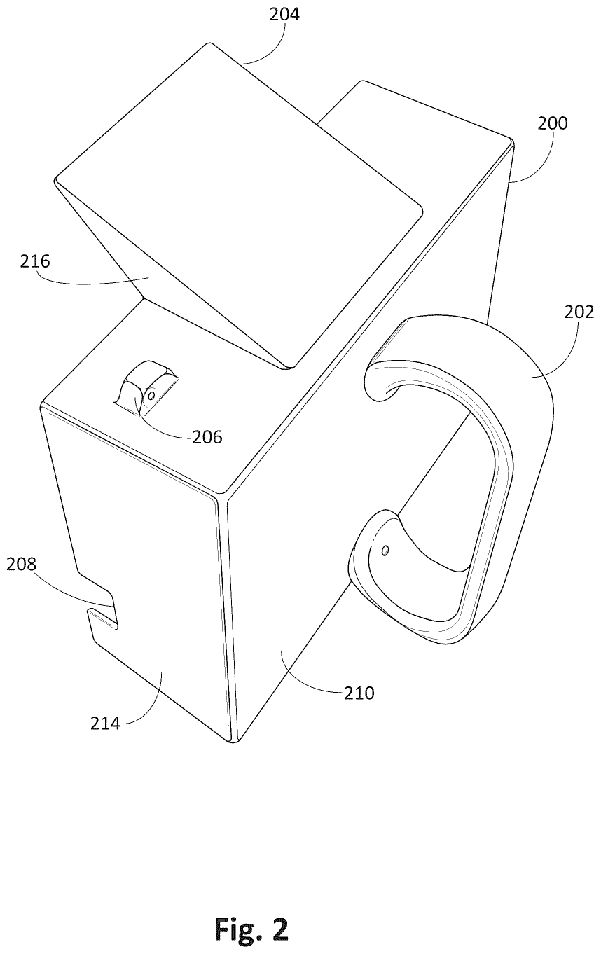

FIG. 2 illustrates an isometric view of an index cover 200 for protecting a smart meter's display components during painting operations. An index cover front surface 210 may form the primary protective barrier of the index cover 200. The index cover front surface 210 may be positioned to face outward when the index cover 200 is installed over a meter index 106, creating a shield against paint overspray and other contaminants. In some cases, the index cover front surface 210 may be configured as a flat or contoured panel that provides coverage for the meter index display 108 and meter index controls 110. An index cover top surface 212 may extend across the upper portion of the index cover 200. The index cover top surface 212 may connect to the index cover front surface 210 to form part of the protective enclosure. In some cases, the index cover top surface 212 may be positioned at an angle relative to the index cover front surface 210 to accommodate the geometric configuration of the meter 100 components. An index cover right surface 214 may form one of the lateral walls of the index cover 200. The index cover right surface 214 may extend from the index cover front surface 210 to provide side protection for the meter index 106. In some cases, the index cover right surface 214 may serve as a mounting point for an index cover handle 202, enabling manual manipulation of the index cover 200 during installation and removal operations.

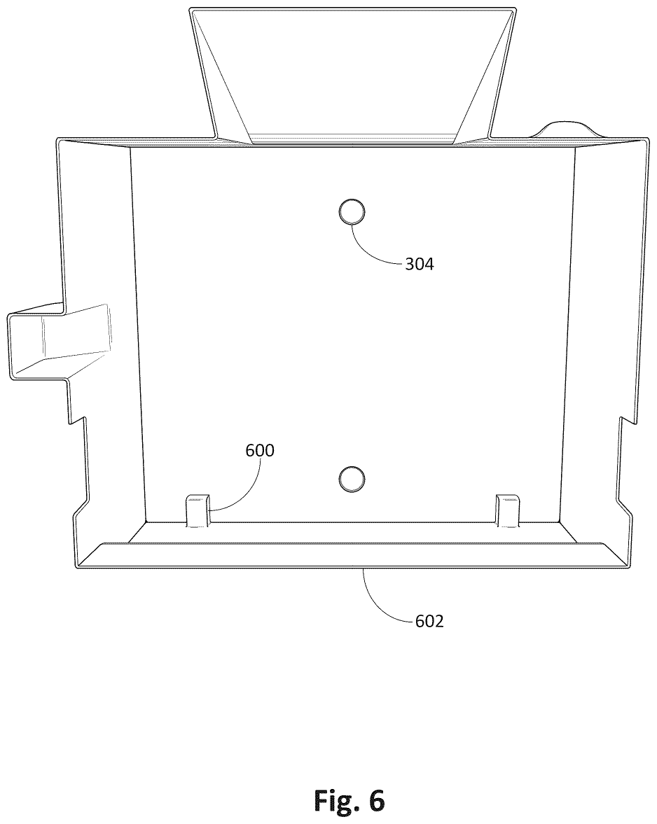

FIG. 6 illustrates a bottom view of the index cover 200. An index cover bottom surface 602 may form the lower portion of the index cover 200 structure. The index cover bottom surface 602 may define the lower boundary of the index cover 200 and may interface with the meter 100 components during installation. In some cases, the index cover bottom surface 602 may be configured with an open bottom configuration, creating a hollow interior space that allows the index cover 200 to be positioned over the meter index 106 without a closed bottom panel.

The index cover 200 may be constructed with specific dimensional configurations to accommodate different meter 100 models and installation requirements. In some cases, the index cover 200 may have dimensions of approximately 7 inches by 6 inches by 2 inches, providing coverage for a meter index 106 configurations. These values can have ranges that are greater or less than 2 inches. Dimensional configurations may include an index cover 200 with dimensions of approximately 6.5 inches by 5.5 inches by 2.25 inches to accommodate different meter 100 sizes or installation constraints. These values can have ranges that are greater or less than 2 inches,

The index cover 200 may be fabricated from plastic material with a thickness in the range of 1/64 to ¼ inch. The plastic material may provide adequate protection against paint overspray while maintaining lightweight characteristics for ease of handling. In some cases, the index cover 200 may be constructed from rigid plastic material that maintains structural integrity during use and provides consistent protection for the meter index 106 components.

The geometric relationship between the index cover front surface 210, index cover top surface 212, index cover right surface 214, and index cover bottom surface 602 may create a box-like structure with an open bottom configuration adapted to receive an index. The open bottom configuration may allow the index cover 200 to be positioned over the meter index 106 without requiring removal of meter 100 components or disconnection of utility connections. In some cases, the index cover bottom surface 602 may include a curved configuration that cups the bottom portion of the meter index 106, providing enhanced fitment and stability during installation.

The protective functions of the index cover 200 surfaces may work together to create a comprehensive barrier against paint contamination. The index cover front surface 210 may shield the meter index display 108 from direct paint application, while the index cover top surface 212 and index cover right surface 214 may protect against overspray from multiple directions. The index cover bottom surface 602 may provide structural support and positioning stability while maintaining access to the meter 100 mounting and connection points.

An index cover handle 202 may be positioned on the index cover 200 to provide a gripping mechanism for manual positioning and removal of the cover. The index cover handle 202 may extend from the index cover front surface, creating a projection that enables single-handed operation during installation and removal procedures. In some cases, the index cover handle 202 may be configured as an elongated element that provides sufficient surface area for secure gripping while maintaining clearance from the meter 100 components during use.

The index cover handle 202 may facilitate manual manipulation of the index cover 200 during painting operations. The index cover handle 202 may enable users to position the index cover 200 over the meter index 106 and hold the index cover 200 in place during paint application procedures. In some cases, the index cover handle 202 may allow for rapid deployment and removal of the index cover 200, reducing the time needed for protective setup compared to traditional masking approaches.

A handle fastener 304 may be positioned on the index cover handle 202 to provide a connection point for securing the handle to the main cover body. The handle fastener 304 may enable attachment of the index cover handle 202 to the index cover 200 structure through mechanical connection methods. In some cases, the handle fastener 304 may be configured as a threaded fastener, snap-fit connector, or other attachment mechanism that maintains the structural integrity of the index cover handle 202 during use.

The handle fastener 304 may be positioned within the index cover bottom surface 602 area, providing a connection point for the handle assembly. The handle fastener 304 may distribute loads from the index cover handle 202 across the index cover 200 structure, preventing localized stress concentrations that could compromise the protective cover during manual operation. In some cases, the handle fastener 304 may be recessed or flush-mounted within the index cover 200 to maintain smooth surface profiles and prevent interference with meter 100 components during installation. The attachment mechanism between the index cover handle 202 and the index cover 200 may involve the handle fastener 304 creating a secure connection that withstands the forces applied during manual positioning operations. The handle fastener 304 may enable the index cover handle 202 to transmit positioning forces to the index cover 200 without causing separation or structural failure. In some cases, the handle fastener 304 may be configured to allow for replacement or repair of the index cover handle 202 if damage occurs during use. In some aspects, the index cover handle 202 may be molded or otherwise integrated with the index cover 200 as a single unified component during manufacturing processes.

The attachment mechanism between the index cover handle 202 and the index cover 200 may involve the handle fastener 304 creating a secure connection that withstands the forces applied during manual positioning operations. The handle fastener 304 may enable the index cover handle 202 to transmit positioning forces to the index cover 200 without causing separation or structural failure. In some cases, the handle fastener 304 may be configured to allow for replacement or repair of the index cover handle 202 if damage occurs during use.

The positioning relationship between the index cover handle 202 and the index cover right surface 214 may provide ergonomic advantages for users during cover installation and removal. The index cover handle 202 may extend laterally from the index cover 200 body, creating clearance between the user's hand and the meter 100 components during operation. In some cases, the index cover handle 202 may be angled or contoured to provide comfortable gripping surfaces that reduce hand fatigue during extended painting operations.

The structural support provided by the handle fastener 304 may enable the index cover handle 202 to function as a manipulation point for the entire index cover 200 assembly. The handle fastener 304 may transfer forces from the index cover handle 202 to the index cover 200 structure, allowing users to position and hold the protective cover using single-handed operation. In some cases, the handle fastener 304 may be configured with sufficient strength characteristics to support the weight of the index cover 200 and resist the forces applied during manual positioning procedures.

An index plate shield 204 may be positioned at the top portion of the index cover 200 to provide extended protective coverage beyond the main display area. The index plate shield 204 may be configured as an angled surface that extends outward from the index cover 200 structure, creating additional protection for meter identification components. In some cases, the index plate shield 204 may be oriented at specific angular relationships relative to the index cover 200 to optimize coverage for different meter 100 configurations and component layouts. The angle can range from 5 to 90 degrees.

The index plate shield 204 may be positioned such that it may provide coverage that extends beyond the primary meter index 106 area to protect additional meter 100 components. In some cases, the angle may create a sloped surface that deflects paint overspray away from meter identification 104 areas while maintaining clearance for meter 100 installation and removal procedures. The plate can be adjustable in angle to accommodate varying mater and meter indexes and provide a different coverage profile that accommodates specific meter 100 geometries or installation constraints. In some cases, the angle may create a more gradual slope that provides extended coverage while minimizing the overall profile of the index cover 200 during storage and transportation.

The index plate shield 204 may be configured to cover meter numbers and bar code when installed over the meter 100. The angled configuration of the index plate shield 204 may extend the protective coverage to encompass meter identification 104 elements that are positioned above or adjacent to the meter index 106. In some cases, the index plate shield 204 may shield alphanumeric identification numbers, barcode labels, and other marking systems that enable utility personnel to identify and track the specific meter 100.

An index plate shield side wall 216 may connect the index plate shield 204 to the main body of the index cover 200. The index plate shield side wall 216 may provide structural continuity between the angled index plate shield 204 and the index cover front surface 210, creating a continuous protective enclosure. In some cases, the index plate shield side wall 216 may be configured as a vertical or angled transition surface that maintains the structural integrity of the index cover 200 while accommodating the angular orientation of the index plate shield 204.

The index plate shield side wall 216 may transfer structural loads from the index plate shield 204 to the main index cover 200 body, preventing localized stress concentrations that could compromise the protective cover during use. The index plate shield side wall 216 may maintain the geometric relationship between the index plate shield 204 and the index cover 200 components, ensuring consistent coverage and protection during painting operations. In some cases, the index plate shield side wall 216 may be configured with sufficient thickness and material properties to resist deformation under the forces applied during manual positioning and paint application procedures.

An index plate shield proximal angle 308 may be formed as part of the angled shield section of the index cover 200. The index plate shield proximal angle 308 may represent the angular surface that is positioned closer to the main body of the index cover 200. In some cases, the index plate shield proximal angle 308 may provide the primary transition from the index cover front surface 210 to the extended coverage area created by the index plate shield 204.

An index plate shield distal angle 310 may be formed as part of the angled shield section of the index cover 200. The index plate shield distal angle 310 may represent the angular surface that extends furthest from the main body of the index cover 200. In some cases, the index plate shield distal angle 310 may provide the outermost protective coverage for meter identification 104 components that are positioned at the greatest distance from the meter index 106.

The relationship between the index plate shield proximal angle 308 and the index plate shield distal angle 310 may create a multi-faceted angled surface that accommodates different meter 100 component geometries and installation configurations. The index plate shield proximal angle 308 may provide coverage for meter identification 104 elements that are positioned immediately adjacent to the meter index 106, while the index plate shield distal angle 310 may extend protection to components that are located at greater distances from the primary display area.

The angular configuration created by the index plate shield proximal angle 308 and the index plate shield distal angle 310 may optimize the protective coverage provided by the index plate shield 204 while maintaining compatibility with different meter 100 models and installation environments. In some cases, the index plate shield proximal angle 308 and the index plate shield distal angle 310 may be configured with different angular orientations to accommodate specific meter 100 component layouts or to provide enhanced protection against paint overspray from multiple directions.

The structural integration of the index plate shield 204, index plate shield side wall 216, index plate shield proximal angle 308, and index plate shield distal angle 310 may create a comprehensive angled protection system that extends the coverage capabilities of the index cover 200 beyond the primary meter index 106 area. The angled configuration may deflect paint overspray away from sensitive meter 100 components while maintaining the structural integrity and ease of use characteristics of the protective cover system.

An index top tab cover 206 may be formed as part of the index cover 200 structure to accommodate corresponding meter 100 features during installation. The index top tab cover 206 may be positioned on the index cover 200 to provide clearance for a meter top tab 116 when the index cover 200 is positioned over the meter index 106. In some cases, the index top tab cover 206 may be configured as an indented area that creates a negative space within the index cover 200 geometry, allowing the meter top tab 116 to fit within the recess without interference during cover placement.

The index top tab cover 206 may be dimensioned to correspond to the physical characteristics of the meter top tab 116, providing sufficient clearance while maintaining structural integrity of the index cover 200. In some cases, the index top tab cover 206 may include depth and width specifications that accommodate manufacturing tolerances and installation variations while ensuring secure fitment of the index cover 200 over the meter 100 components.

An index left seam cover 208 may be formed within the index cover 200 to provide accommodation for meter seam 118 features positioned on the left side of the meter 100. The index left seam cover 208 may be configured as a recessed area that creates clearance for structural elements of the meter 100 housing during index cover 200 installation. In some cases, the index left seam cover 208 may be positioned to align with the meter seam 118 when the index cover 200 is properly positioned over the meter index 106.

The index left seam cover 208 may extend along a portion of the index cover 200 structure to accommodate the linear characteristics of the meter seam 118. In some cases, the index left seam cover 208 may be configured with specific depth and profile characteristics that correspond to the raised or recessed features of the meter seam 118, enabling the index cover 200 to fit flush against the meter 100 surface during installation.

An index side tab cover 300 may be incorporated into the index cover 200 design to provide clearance for lateral meter 100 features during cover positioning. The index side tab cover 300 may be formed as a recessed area along one side of the index cover 200 structure, creating accommodation space for meter 100 components that extend beyond the primary meter index 106 area. In some cases, the index side tab cover 300 may be positioned to align with specific meter 100 structural elements that require clearance during index cover 200 installation.

The index side tab cover 300 may facilitate secure positioning of the index cover 200 during installation and use. The index side tab cover 300 may provide a reference point for proper alignment of the index cover 200 relative to the meter 100 components, enabling consistent positioning across multiple installation and removal cycles. In some cases, the index side tab cover 300 may be configured with geometric features that create a positive engagement with corresponding meter 100 elements, enhancing the stability of the index cover 200 during painting operations.

An index right seam cover 302 may be formed within the index cover 200 to accommodate meter seam 118 features positioned on the right side of the meter 100. The index right seam cover 302 may be configured as a recessed area that provides clearance for meter 100 housing elements during index cover 200 positioning. In some cases, the index right seam cover 302 may be positioned to correspond with the meter seam 118 location when the index cover 200 is installed over the meter index 106.

The index right seam cover 302 may complement the index left seam cover 208 to provide bilateral accommodation for meter seam 118 features. The index right seam cover 302 may be dimensioned to match the geometric characteristics of the meter seam 118 on the right side of the meter 100, enabling the index cover 200 to achieve proper fitment without interference from meter 100 structural elements. In some cases, the index right seam cover 302 may include depth and profile specifications that correspond to the specific meter 100 model configurations.

The relationship between the index top tab cover 206, index left seam cover 208, index side tab cover 300, and index right seam cover 302 may create a comprehensive accommodation system that enables the index cover 200 to fit over various meter 100 configurations. The recess features may work together to provide clearance for multiple meter 100 structural elements simultaneously, allowing the index cover 200 to achieve secure positioning without requiring modification of the meter 100 installation.

The positioning of the index top tab cover 206 relative to the index side tab cover 300 may provide accommodation for meter 100 features that are positioned at different elevations and orientations on the meter 100 housing. The index top tab cover 206 may address vertical clearance requirements while the index side tab cover 300 may provide lateral accommodation, creating a multi-dimensional fitment system within the index cover 200 structure.

The geometric relationship between the index left seam cover 208 and the index right seam cover 302 may provide bilateral accommodation for meter seam 118 features that extend across the width of the meter 100. The index left seam cover 208 and index right seam cover 302 may be positioned at corresponding locations on opposite sides of the index cover 200, creating symmetrical clearance areas that accommodate the meter seam 118 configuration.

The recess system may enable the index cover 200 to achieve consistent positioning across different meter 100 installations while maintaining the protective coverage functions. The index top tab cover 206, index left seam cover 208, index side tab cover 300, and index right seam cover 302 may provide reference points for proper alignment during index cover 200 installation, reducing the potential for misalignment or inadequate coverage during painting operations.

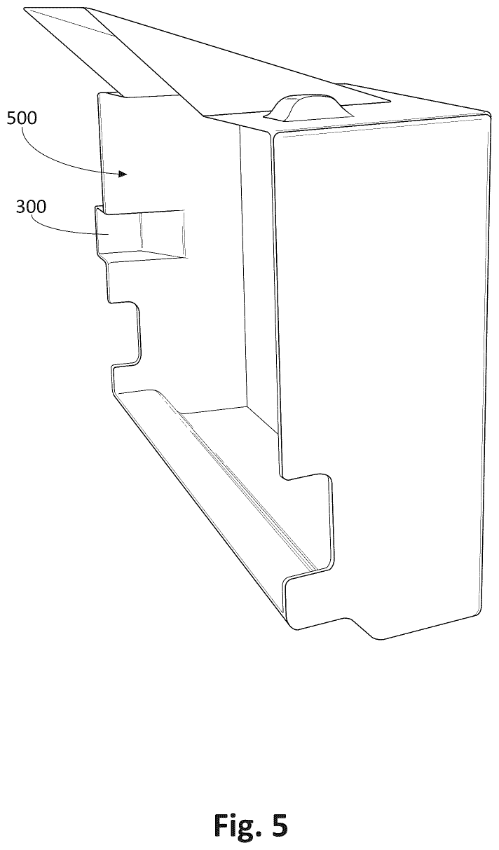

FIG. 5 illustrates an isometric view of an index cover component. A cover index cavity 500 may be formed within the index cover 200 structure to provide an internal accommodation space for meter index 106 components. The cover index cavity 500 may create a hollow interior chamber that enables the index cover 200 to be positioned over the meter index 106 without physical interference with the enclosed components. In some cases, the cover index cavity 500 may be dimensioned to provide clearance for the meter index display 108, meter index controls 110, and other meter index 106 elements while maintaining protective coverage during painting operations.

The cover index cavity 500 may be configured with sufficient internal volume to house the meter index 106 components while allowing for installation tolerances and meter 100 variations. In some cases, the cover index cavity 500 may include depth specifications that accommodate the three-dimensional profile of the meter index 106, including any protruding elements or recessed areas that extend beyond the primary mounting surface of the meter 100. The cover index cavity 500 may provide clearance for the meter index display 108 screen surface while maintaining adequate separation distance to prevent contact during index cover 200 positioning and removal procedures.

The geometric configuration of the cover index cavity 500 may correspond to the external dimensions and shape characteristics of the meter index 106. The cover index cavity 500 may be formed with internal wall surfaces that follow the contours of the meter index 106 housing, creating a complementary negative space that accommodates the meter 100 components. In some cases, the cover index cavity 500 may include tapered or angled internal surfaces that facilitate alignment during index cover 200 installation while providing consistent clearance across the meter index 106 area.

The cover index cavity 500 may enable the index cover 200 to achieve secure positioning over the meter index 106 without requiring removal or disconnection of meter 100 components. The cover index cavity 500 may accommodate the meter index 106 in the installed configuration, allowing painting operations to proceed without disruption to utility service or meter 100 functionality. In some cases, the cover index cavity 500 may be configured to provide access clearance for meter 100 mounting hardware and connection points while maintaining protective coverage for the meter index display 108 and meter index controls 110.

FIG. 6 illustrates a bottom view of the index cover 200. A structural support 600 may be positioned within the index cover 200 to provide reinforcement to the cover assembly during use. The structural support 600 may extend across the index cover bottom surface 602, creating internal bracing that distributes loads and maintains the structural integrity of the index cover 200 during manual operation. In some cases, the structural support 600 may be configured as a rib, beam, or framework element that spans the width or length of the index cover bottom surface 602 to resist deformation under applied forces.

The structural support 600 may provide reinforcement against bending or flexing of the index cover 200 when forces are applied through the index cover handle 202 during positioning operations. The structural support 600 may transfer loads from localized application points to the broader index cover 200 structure, preventing stress concentrations that could compromise the protective cover during use. In some cases, the structural support 600 may be positioned to align with the handle fastener 304 location, providing enhanced support for the connection point between the index cover handle 202 and the index cover 200 assembly.

The structural support 600 may maintain the dimensional stability of the cover index cavity 500 during manual manipulation of the index cover 200. The structural support 600 may resist deformation of the index cover bottom surface 602 that could alter the internal clearance provided by the cover index cavity 500 for the meter index 106 components. In some cases, the structural support 600 may be configured with sufficient stiffness characteristics to maintain the geometric relationship between the index cover 200 surfaces while accommodating the forces applied during installation and removal procedures.

The positioning of the structural support 600 relative to the cover index cavity 500 may optimize the reinforcement provided to the index cover 200 while maintaining the internal accommodation space for the meter index 106. The structural support 600 may be located to avoid interference with the cover index cavity 500 volume while providing structural continuity across the index cover bottom surface 602. In some cases, the structural support 600 may be integrated with the index cover bottom surface 602 through molding or forming processes that create a unified structural assembly.

The structural support 600 may enable the index cover 200 to maintain protective coverage consistency across multiple installation and removal cycles. The structural support 600 may prevent fatigue or degradation of the index cover 200 structure that could result from repeated manual positioning operations during painting procedures. In some cases, the structural support 600 may be configured with material properties and geometric characteristics that provide long-term durability while maintaining the lightweight handling characteristics of the index cover 200 assembly.

The relationship between the cover index cavity 500 and the structural support 600 may create a balanced design that accommodates the meter index 106 while providing structural integrity for the protective cover system. The cover index cavity 500 may define the internal accommodation space while the structural support 600 may maintain the external dimensional stability of the index cover 200 during use. In some cases, the cover index cavity 500 and structural support 600 may be configured to work together to provide consistent protective coverage and reliable operation across different meter 100 configurations and installation environments.

The protective cover system described herein may provide several advantages over traditional masking methods used during painting operations near utility meters. Conventional masking approaches may involve applying tape, paper, and other adhesive materials around individual meter components, which can be time-consuming and labor-intensive. The process of carefully masking displays, identification numbers, barcodes, and various meter features may require significant preparation time before painting can commence. Traditional masking techniques may also fail to provide adequate protection for the complex geometries found in modern smart meters, which often include multiple protruding elements, recessed areas, and angled surfaces that can be difficult to protect using standard flat masking materials.

The index cover 200 may address these limitations by providing a pre-formed protective enclosure that can be rapidly positioned over meter components without requiring careful application of individual masking materials. The index cover 200 may be deployed in a single positioning operation, eliminating the time needed to apply and align multiple pieces of tape or paper around complex meter geometries. In some cases, the index cover 200 may reduce setup time from several minutes of careful masking to a few seconds of cover placement.

The three-dimensional configuration of the index cover 200 may provide comprehensive protection that accommodates the irregular shapes and varying depths of meter components. The cover index cavity 500 may be specifically configured to accommodate the meter index 106 geometry, while the index plate shield 204 may extend protection to meter identification 104 areas that are positioned at different elevations and angles. The recess features may enable the index cover 200 to fit around meter structural elements without gaps that could allow paint penetration.

Traditional masking methods may create gaps in protection where paint overspray can penetrate and contaminate sensitive areas, particularly around complex three-dimensional meter features. The index cover 200 may eliminate these protection gaps by providing a continuous barrier that follows the contours of the meter components. The angled configuration of the index plate shield 204 may deflect paint overspray away from meter identification areas, while the cover index cavity 500 may create a protected environment for the meter index display 108 and meter index controls 110.

The index cover 200 may be used for temporary protection during painting of components in close proximity to meter installations. When painting operations occur near utility meters, the index cover 200 may be positioned to shield meter components from paint overspray that could interfere with meter functionality or readability. The temporary nature of the protection allows painting operations to proceed without requiring permanent modification or disconnection of meter installations.

The index cover 200 may be used for protecting during brush painting operations where precise paint application may still result in inadvertent contact with meter components. Brush painting techniques may involve paint application in close proximity to meter installations, where brush movement or paint dripping could contaminate meter surfaces. The index cover 200 may provide a protective barrier that prevents paint contact while allowing painting operations to continue around the meter area.

Paint contamination of meter components may interfere with meter functionality in several ways that the index cover 200 may prevent. Paint applied to display screens can obscure readings and make meter data inaccessible to utility personnel. Paint covering identification numbers, barcodes, or communication components can prevent proper meter identification and data transmission. The index cover 200 may shield these components from paint contamination, maintaining meter functionality and readability throughout painting operations.

The removal of paint from meter components after contamination has occurred can be problematic and may damage sensitive electronic components or void manufacturer warranties. Paint that has cured on meter surfaces may be particularly difficult to remove without causing permanent damage to the underlying components. The index cover 200 may prevent paint contamination from occurring, eliminating the need for potentially damaging paint removal procedures.

The index cover handle 202 may facilitate rapid deployment and removal during painting operations, providing advantages over traditional masking approaches that require careful application and removal of adhesive materials. The index cover handle 202 may enable single-handed operation, allowing painters to position and hold the protective cover while continuing painting operations with the other hand. In some cases, the index cover 200 may be held in position manually during paint application, providing flexible protection that can be adjusted as needed during the painting process.

The reusable nature of the index cover 200 may provide economic advantages over disposable masking materials that are discarded after each use. Traditional masking materials may represent ongoing costs for each painting operation, while the index cover 200 may be used repeatedly across multiple painting projects. The durable construction of the index cover 200 may enable extended service life, reducing the long-term costs associated with meter protection during painting operations.

The process of using the index cover 200 may involve a sequence of installation, positioning, and removal operations that provide temporary protection for meter components during painting procedures. The process may enable painters to shield sensitive meter areas while conducting painting operations in proximity to utility installations.

The installation process may begin with positioning an index cover 200 relative to a meter 100 that contains components requiring protection from paint contamination. The meter 100 may include a meter index 106 that houses display and control elements that may be susceptible to paint damage. The index cover 200 may be configured to provide protective coverage for the meter index 106 during painting operations.

The positioning phase may involve moving the index cover 200 in a placement direction 120 to achieve proper alignment with the meter index 106. The placement direction 120 may define the movement path that enables the index cover 200 to be positioned over the meter index 106 without interference from meter 100 structural elements. In some cases, the placement direction 120 may involve a linear movement that brings the index cover 200 into contact with the meter 100 surface while aligning the cover index cavity 500 with the meter index 106 components.

The index cover 200 may be moved in the placement direction 120 until the cover index cavity 500 encompasses the meter index 106 area. The placement direction 120 may enable the index cover 200 to slide over the meter index 106 while the recess features accommodate meter 100 structural elements. In some cases, the placement direction 120 may involve a perpendicular approach to the meter 100 surface that allows the index cover 200 to be positioned without requiring angular adjustment or complex alignment procedures.

The securing phase may involve positioning the index cover 200 against the meter 100 surface to create a stable protective barrier. The index cover 200 may be held in position through manual contact using the index cover handle 202, which may provide a gripping surface for maintaining cover placement during painting operations. In some cases, the index cover 200 may be secured by ensuring that the recess features engage with corresponding meter 100 elements to prevent movement during paint application.

The index cover handle 202 may be grasped to maintain the position of the index cover 200 over the meter index 106 throughout the painting process. The index cover handle 202 may enable single-handed operation, allowing the user to hold the index cover 200 in place while conducting painting operations with the other hand. In some cases, the index cover handle 202 may provide sufficient leverage to maintain secure positioning of the index cover 200 against the meter 100 surface during paint application procedures.

The painting phase may proceed with the index cover 200 positioned to shield the meter index 106 from paint overspray and direct paint application. Paint may be applied to surfaces in proximity to the meter 100 while the index cover 200 provides protective coverage for sensitive meter components. In some cases, brush painting techniques may be used with the index cover 200 providing protection against inadvertent brush contact with the meter index 106 area.

Spray painting operations may be conducted with the index cover 200 providing barrier protection against paint overspray that could contaminate the meter index 106 components. The index cover 200 may deflect paint particles away from the meter index 106 while allowing painting operations to continue around the meter 100 installation. In some cases, the angled configuration of the index plate shield 204 may direct paint overspray away from meter identification areas that extend beyond the primary meter index 106 coverage area.

The index cover 200 may remain in position throughout the duration of paint application procedures, providing continuous protection for the meter index 106 components. The cover may shield the meter index display 108 and meter index controls 110 from paint contamination while painting operations proceed on adjacent surfaces. In some cases, the index cover 200 may be repositioned during painting operations by adjusting the placement direction 120 to accommodate different paint application angles or coverage areas.

The removal phase may begin after painting operations have been completed and paint application in the meter 100 vicinity is no longer occurring. The index cover 200 may be removed by reversing the placement direction 120 to withdraw the cover from the meter index 106 area. In some cases, the index cover handle 202 may be used to lift the index cover 200 away from the meter 100 surface while ensuring that the cover index cavity 500 clears the meter index 106 components without contact.

The index cover 200 may be moved in a direction opposite to the placement direction 120 to disengage the cover from the meter 100 installation. The removal process may involve lifting the index cover 200 away from the meter 100 surface while maintaining clearance for the meter index 106 components. In some cases, the removal may be accomplished through a single motion that withdraws the index cover 200 from the meter index 106 area without requiring complex maneuvering or angular adjustment.

The completion of the removal process may restore full access to the meter index 106 components while leaving the meter 100 installation unchanged from the pre-painting configuration. The meter index display 108 and meter index controls 110 may remain protected from paint contamination, maintaining meter functionality and readability. In some cases, the index cover 200 may be cleaned and stored for reuse in subsequent painting operations, providing ongoing protection capabilities for multiple meter installations.

The process may be repeated for multiple meter 100 installations within a painting project area, with the index cover 200 providing consistent protection across different meter configurations. The standardized installation and removal procedures may enable efficient protection deployment across multiple utility meter locations. In some cases, the process may be adapted to accommodate different meter 100 models or installation configurations while maintaining the protective coverage functions of the index cover 200 system.

The index cover 200 may provide significant efficiency improvements over traditional meter protection methods during painting operations. Conventional masking approaches may require several minutes of careful tape and paper application around individual meter components, while the index cover 200 may be deployed in a matter of seconds through a single positioning motion. The pre-formed protective enclosure may eliminate the time-consuming process of measuring, cutting, and applying multiple pieces of masking material around complex meter geometries. In some cases, the index cover 200 may reduce protection setup time by up to 90% compared to traditional masking methods, allowing painting crews to complete meter protection tasks more rapidly and proceed with painting operations without extended preparation delays. The standardized installation procedure may enable consistent deployment across multiple meter installations, further enhancing operational efficiency during large-scale painting projects.

A number of implementations have been described. Nevertheless, it will be understood that various modifications may be made without departing from the spirit and scope of the disclosure. Accordingly, other implementations are within the scope of the following claims.

1. A system for uniquely tagging and verifying authenticity of an article comprising:
the article having a surface;
a holographic interference pattern created according to a three-dimensional predetermined image wherein the holographic interference pattern is applied to the surface of the article;
a three-dimensional resulting image projected on a planar surface in response to the holographic interference pattern being illuminated by a first coherent light source; and,
a validation information created according to a comparison of the three-dimensional predetermined image and the three-dimensional resulting image.

2. The system of claim 1 including a computerized validation system adapted to receive the three-dimensional predetermined image, receive the three-dimensional resulting image, and create the validation information according to the comparison of the three-dimensional predetermined image and the three-dimensional resulting image.

3. The system of claim 1 wherein the holographic interference pattern, when applied to the article, includes a first refractive index and a second refractive index, wherein the three-dimensional resulting image is formed according to the holographic interference pattern, the first refractive index, and the second refractive index.

4. The system of claim 1 wherein the holographic interference pattern is created according to a creation computerized system adapted to create the three-dimensional predetermined image according to the three-dimensional predetermined image and at least one physical characteristic of the surface of the article object.

5. The system of claim 1 wherein the three-dimensional resulting image is projected on the planar surface by a beam splitter.

6. The system of claim 5 including a computerized validation system adapted to receive the three-dimensional predetermined image, receive the three-dimensional resulting image, and create the validation information according to the comparison of the three-dimensional predetermined image and the three-dimensional resulting image.

7. The system of claim 5 wherein the beam splitter directs the first coherent light source to the holographic interference pattern and the three-dimensional resulting image is reflected on the planar surface.

8. The system of claim 7 wherein the beam splitter changes a direction of the first coherent light source by less than 90 degrees so that the three-dimensional resulting image is projected from the holographic interference pattern to the planar surface without passing through the beam splitter.

9. The system of claim 1 including an identifier applied to the article and having a predetermined alignment with the holographic interference pattern.

10. The system of claim 9 including a computerized validation system adapted to receive an image of the article having the identifier and the holographic interference pattern, determine a position of the identifier in relation to the holographic interference pattern and create an alignment verification information representation that the identifier and the holographic interference pattern applied to the article are consistent with the predetermined alignment.

11. The system of claim 9 wherein the identifier includes information taken from the group consisting of a logo, bar code, alpha numeric text, QR code, manufacturer information, manufacturing location, product description, manufacturing date, lot, expiry, ingredients, contents, and any combination thereof.

12. The system of claim 1 wherein the holographic interference pattern is affixed to a substrate and the substrate is affixed to the article.

13. The system of claim 12 wherein an identifier is affixed to the substrate.

14. The system of claim 13 wherein the identifier is affixed to the substrate according to a predetermined alignment.

15. The system of claim 12 wherein the substrate is taken from the group consisting of a glass surface, curved surface, sticker, adhesive, plastic, metal, ceramic, and any combination thereof.

16. The system of claim 12 wherein the holographic interference pattern is created according to a reflective property of the substrate.

17. The system of claim 12 wherein the holographic interference pattern is created according to a reflective index associated with the substrate.

18. The system of claim 1 wherein the holographic interference pattern is illuminated by a light having an orbital angular momentum.

19. A system for uniquely tagging and verifying authenticity of an article comprising:
the article having a surface;
a computer system adapted to:
receive a three-dimensional predetermined image,
create a holographic interference pattern created according to the three-dimensional predetermined image and at least one physical property of the surface of the object, wherein the holographic interference pattern is applied to the article,
receive a three-dimensional resulting image that is projected on a planar surface in response to the holographic interference pattern being illuminated; and,
create validation information according to a comparison of the three-dimensional predetermined image and the three-dimensional resulting image.

20. A system for uniquely tagging and verifying authenticity of an article comprising:
the article having a holographic interference pattern and identifier disposed on a substrate affixed to a surface of the article;
a three-dimensional predetermined image; and,
a computerized system adapted to create the holographic interference pattern according to the three-dimensional predetermined image and a curvature, illuminate the holographic interference pattern with a coherent light source, produce a three-dimensional resulting image according to an illumination of the holographic interference pattern and create validation information according to a comparison of the three-dimensional predetermined image and the three-dimensional resulting image.

21. The system of claim 1 where in the article is currency.

22. The system of claim 19 where in the article is currency.

23. The system of claim 20 where in the article is currency.

24. A system for uniquely tagging and verifying objects comprising:
an article having a holographic interference pattern and identifier disposed on a substrate affixed to a surface of the article;
a three-dimensional predetermined image; and,
a computerized system adapted to create the holographic interference pattern according to the three-dimensional predetermined image, illuminate the holographic interference pattern with a coherent light source, produce a three-dimensional resulting image according to an illumination of the holographic interference pattern and create validation information according to a comparison of the three-dimensional predetermined image and the three-dimensional resulting image.

25. [symbol] is currency.is paper.Please enter the Preliminary Amendments provided below.
